(19) United States
(12) Patent Application Publication
(10) Pub. No.: US 2018/0067517 A1
(43) Pub. Date: Mar. 8, 2018

(54) CONTENT CONTROL DEVICE AND DISPLAY SYSTEM

(71) Applicant: Panasonic Intellectual Property Management Co., Ltd., Osaka (JP)

(72) Inventor: Koji SASAKI, Osaka (JP)

(21) Appl. No.: 15/668,161

(22) Filed: Aug. 3, 2017

(30) Foreign Application Priority Data
Sep. 6, 2016 (JP) 2016-173827

(51) Int. Cl. G06F 1/16; G06F 3/14; H04L 29/08

(52) U.S. Cl. CPC G06F 1/1605; H04L 67/025; G06F 3/1446; G06F 3/1431

(57) ABSTRACT

Content control device (30) according to the present disclosure includes information obtaining unit (102) that performs communication with a plurality of display terminal devices by being connected to network (20) through the network, and obtains terminal information of the plurality of display terminal devices, information analyzing unit (103) that extracts position information and terminal specific information of the plurality of display terminal devices by analyzing the terminal information, setting unit (105) that sets reproduction content information displayed on the plurality of display terminal devices and time information, terminal display unit (104) that displays and sets information obtained by associating the position information with the reproduction content information, and terminal control unit (106) that delivers the reproduction content information to each of the plurality of display terminal devices, and transmits a control signal for performing resetting of the position information, based on the reproduction content information and the time information.

### BACKGROUND

### 1. Technical Field

The present disclosure relates to a content control device and a display system.

### 2. Description of the Related Art

In PTL 1, a display system in which contents are displayed by using a plurality of display devices is disclosed. This display system registers a plurality of communication terminals connected to a local area network (hereinafter, referred to as LAN) in management information, and includes a delivery management system that manages a state of a communication terminal of a management target and a delivery control system that provides data to be delivered to a communication terminal and controls the communication terminal. In addition, the communication terminal includes a display circuit that displays data based on a control instruction. With this, it is possible to associate data desired to be delivered by a user with the communication terminal and to deliver the data to each communication terminal based on a state of the managed communication terminal.

### CITATION LIST

### Patent Literature

PTL 1: Japanese Patent Unexamined Publication No. 2015-072446 However, in a display system that performs multi-display by using a plurality of display terminal devices, in order to set content to be delivered to the plurality of display terminal devices, it is necessary to match a position relationship between a position of each display terminal on an operation screen on which a user's operation is performed and an installation position of each display terminal device. Furthermore, there was a problem that it is necessary to grasp specific information (terminal name, IP address information, or the like) of each display terminal device.

### SUMMARY

In a display system of performing multi-display using a plurality of display terminal devices, the present disclosure provides a content control device and a display system capable of setting content desired to be delivered to the plurality of display terminal devices by a simple operation as compared with the related art.

A content control device according to an aspect of the present disclosure includes an information obtaining unit that obtains terminal information of a plurality of display terminal devices by being connected to a network through the network and performing communication with a plurality of display terminal devices displaying predetermined; an information analyzing unit that extracts position information and terminal specific information of the plurality of display terminal devices by analyzing the obtained terminal information; a setting unit that sets reproduction content information to be displayed on the plurality of display terminal devices and time information to be reproduced; a terminal display unit that displays and sets information obtained by associating the extracted position information with the set reproduction content information; and a terminal control unit that delivers the set reproduction content information to the plurality of display terminal devices, and performs transmitting a control signal for performing resetting of the position information based on the set reproduction content information and the set time information.

Accordingly, according to a content control device of the present disclosure, it is possible to set content to be delivered to a plurality of display terminal devices by a simple operation as compared with the related art.

### BRIEF DESCRIPTION OF THE DRAWINGS

FIG. 1A is a block diagram illustrating a configuration example of a display system in which a content control device is provided according to an embodiment.

FIG. 1B is a block diagram illustrating the configuration example of the content control device of FIG. 1A.

FIG. 2 is a block diagram illustrating a configuration example of a terminal information obtaining and setting circuit of FIG. 1B.

FIG. 3 is a block diagram illustrating a configuration example of a position information analyzing circuit of FIG. 1B.

FIG. 4 is a block diagram illustrating a configuration example of a terminal display circuit of FIG. 1B.

FIG. 5 is a block diagram illustrating a configuration example of a content schedule setting circuit of FIG. 1B.

FIG. 6 is a block diagram illustrating a configuration example of a terminal control circuit of FIG. 1B.

FIG. 7 is a diagram illustrating an example of an arrangement state of a plurality of display terminal devices in a multi-display device of FIG. 1A.

FIG. 8 is a diagram illustrating an example of terminal information obtained in the terminal information obtaining and setting circuit of FIG. 1B.

FIG. 9 is a diagram illustrating an arrangement example of a plurality of display terminal devices of the multi-display device of FIG. 1A.

FIG. 10 is a diagram illustrating an example of a content setting operation screen displayed by the terminal display circuit of FIG. 1B.

FIG. 11 is a diagram for explaining an example of setting change of position information in the plurality of display terminal devices by the terminal display circuit of FIG. 1B.

FIG. 12 is a diagram illustrating an example of the content setting operation screen displayed by the terminal display circuit of FIG. 1B.

FIG. 13 is a diagram for explaining an example of setting change of group information in the plurality of display terminal devices by the terminal display circuit of FIG. 1B.

### DETAILED DESCRIPTION

Hereinafter, embodiments will be described in detail with reference to the drawings as appropriate. However, there is a case where detailed explanation more than necessary is omitted. For example, there are cases where detailed descriptions of well-known matters and redundant explanations on substantially the same configuration are omitted. This is to avoid the unnecessary redundancy of the following description and to facilitate understanding by those skilled in the art.

The accompanying drawings and the following description are provided to enable those skilled in the art to sufficiently understand the present disclosure, and they are not intended to limit the claims.

In the related art, in a display system that performs multi-display by using a plurality of display terminal devices, there were the following problems in order to set content to be delivered to the display terminal device that is installed.

(1) It is necessary to match a position relationship between a position of each display terminal device on an operation screen on which a user's operation is performed and an installation position of each display terminal device.

(2) Management information for grasping specific information (terminal name, IP address information, or the like) as a communication terminal of each display terminal device is required.

(3) When replacement of each display terminal device or the like occurs, it takes time and trouble to synchronously perform change of position information of the display terminal device and content delivery information.

A content control device in the present embodiment can automatically change setting of the position of the display terminal device by analyzing the position information set in the display terminal device and by rebuilding the operation screen operated by a user. With this, the user can install the display terminal device without worrying about an arrangement state of display terminals on the operation screen. In addition, provided is a content control device capable of simply associating content desired to be delivered, with a predetermined display terminal device by a user's operation, and a display system including the content control device.

### Embodiment

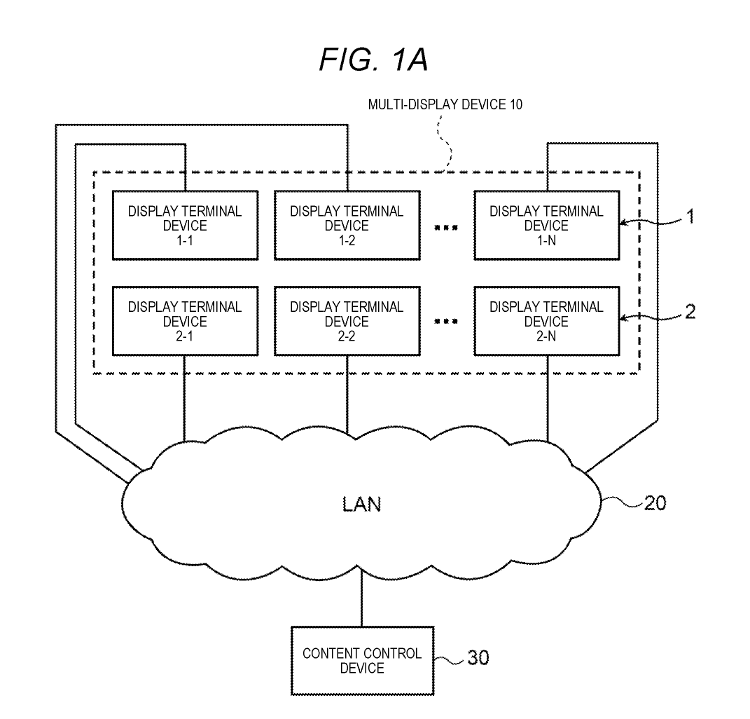

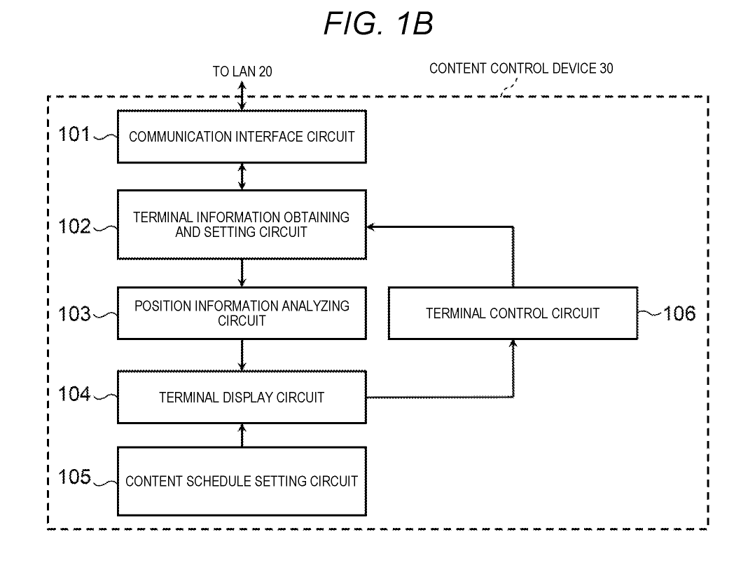

Hereinafter, an embodiment will be described with reference to FIG. 1A to FIG. 11.

### 1-1 Configuration

### 1-1-1. Configuration of Content Control Device and Display System

FIG. 1A is a block diagram illustrating a configuration example of the display system in which content control device 30 according to the embodiment is provided. FIG. 1B is a block diagram illustrating a configuration example of content control device 30 of FIG. 1A.

In FIG. 1A, the display system according to the embodiment includes multi-display device 10 configured by the plurality of display terminal devices 1-1 to 1-N and 2-1 to 2-N (hereinafter, in order to simplify reference numerals 1 and 2 are collectively attached), LAN 20, and content control device 30. Here, display terminal devices 1 and 2 are connected to content control device 30 through LAN 20. In addition, an image displayed on each of display terminal devices 1 and 2 is controlled by content control device 30.

Each of the plurality of display terminal devices 1 and 2 includes a display on which an image is displayed, a display control device that controls the display, and a communication interface circuit that is connected to the display control device and LAN 20. Multi-display device 10 is configured by arranging each display of the plurality of display terminal devices 1 and 2 in a matrix format. In an example of FIG. 1A, an arrangement example of display terminal devices 1 and 2 of 2 rows and N columns is illustrated. In addition, each of the plurality of display terminal devices 1 and 2 includes the communication interface circuit. The communication interface circuit is connected to content control device 30 through LAN 20. In the present embodiment, display terminal devices 1 and 2 are connected to content control device 30 through LAN 20, but is not limited thereto. For example, display terminal devices 1 and 2 may be connected to content control device 30 through another network such as the Internet.

In FIG. 1B, content control device 30 includes communication interface circuit 101, terminal information obtaining and setting circuit 102, position information analyzing circuit 103, terminal display circuit 104, content schedule setting circuit 105, and terminal control circuit 106.

Communication interface circuit 101 is connected to the communication interface circuit of the plurality of display terminal devices 1 and 2 through LAN 20. Image data to be displayed on each of display terminal devices 1 and 2 and a control signal for controlling an operation of each of display terminal devices 1 and 2 are transmitted to and received from each of display terminal devices 1 and 2 through communication interface circuit 101. In addition, communication interface circuit 101 is connected to terminal information obtaining and setting circuit 102, and performs transmission and reception of predetermined data and the control signal.

Terminal information obtaining and setting circuit 102 performs communication by a predetermined procedure and the communication interface circuit of each of display terminal devices 1 and 2. With this, terminal information obtaining and setting circuit 102 obtains the terminal information of each of display terminal devices 1 and 2 through communication interface circuit 101 and LAN 20. Terminal specific information or the like such as the position information of display terminal devices 1 and 2, the terminal name, and the IP address are included in the terminal information. In addition, terminal information obtaining and setting circuit 102 transmits the control signal created in terminal control circuit 106, which will be described below, to the communication interface circuit of predetermined display terminal devices 1 and 2 through communication interface circuit 101 and LAN 20. The control signal created in terminal control circuit 106 includes a control command for display terminal devices 1 and 2.

It is assumed that the position information of display terminal devices 1 and 2 is stored in a non-volatile memory within the communication interface circuit of each of display terminal devices 1 and 2 by an arranger (user). The position information of display terminal devices 1 and 2 mentioned here means the position information of display terminal devices 1 and 2 in a case of arranging to constitute multi-display device 10.

Position information analyzing circuit 103 is connected to terminal information obtaining and setting circuit 102. Position information analyzing circuit 103 analyzes terminal information obtained by terminal information obtaining and setting circuit 102, and extracts the position information and the terminal specific information of display terminal devices 1 and 2. The position information and the terminal specific information that are extracted is output to terminal display circuit 104.

Terminal display circuit 104 is connected to position information analyzing circuit 103. Terminal display circuit 104 creates operation screen information for performing a user's operation based on the position information of each of display terminal devices 1 and 2 analyzed and extracted in position information analyzing circuit 103. In addition, terminal display circuit 104 creates delivery content list screen information based on content information to be delivered registered in advance in content schedule setting circuit 105. The user can perform association of a predetermined terminal and the content information desired to be delivered by a delivery content list screen.

Here, terminal display circuit 104 outputs delivery information to be delivered to each of display terminal devices 1 and 2 to terminal control circuit 106, at a time at which the operation screen information illustrating the position information of display terminal devices 1 and 2, and information of setting the content information associated with each of display terminal devices 1 and 2 are confirmed. The content information and time information for performing content which will be described below are included in the delivery information.

Content schedule setting circuit 105 is connected to terminal display circuit 104. The content information to be delivered is registered in advance in content schedule setting circuit 105. In addition, content schedule setting circuit 105 creates the content information and a delivery schedule of content from the time information, and outputs the created information and schedule to terminal display circuit 104.

Terminal control circuit 106 is connected to terminal information obtaining and setting circuit 102 and terminal display circuit 104. Terminal control circuit 106 sets the control command required for controlling specific display terminal devices 1 and 2 from the content information to be delivered to each of display terminal devices 1 and 2, and terminal information based on the reproduction content information and the time information set in terminal display circuit 104.

Terminal display circuit 104 can associate each of display terminal devices 1 and 2 with the content information to be delivered to each of display terminal devices 1 and 2. In addition, terminal display circuit 104 can create and display current position information of display terminal devices 1 and 2, the terminal specific information, and the like. In a case where there is an inconsistency between actual installation positions of display terminal devices 1 and 2 and positions on the operation screen, or in a case where rearrangement is required, the position information of display terminal devices 1 and 2 desired to be changed is changed by a user's operation. The changed content controls display terminal devices 1 and 2 through terminal control circuit 106. An operation of setting the position information may be performed to perform the multi-display while maintaining the current arrangement position without changing physically arrangement positions of display terminal devices 1 and 2.

Next, a configuration example of each circuit will be described in detail.

### 1-1-2. Configuration of Terminal Information Obtaining and Setting Circuit

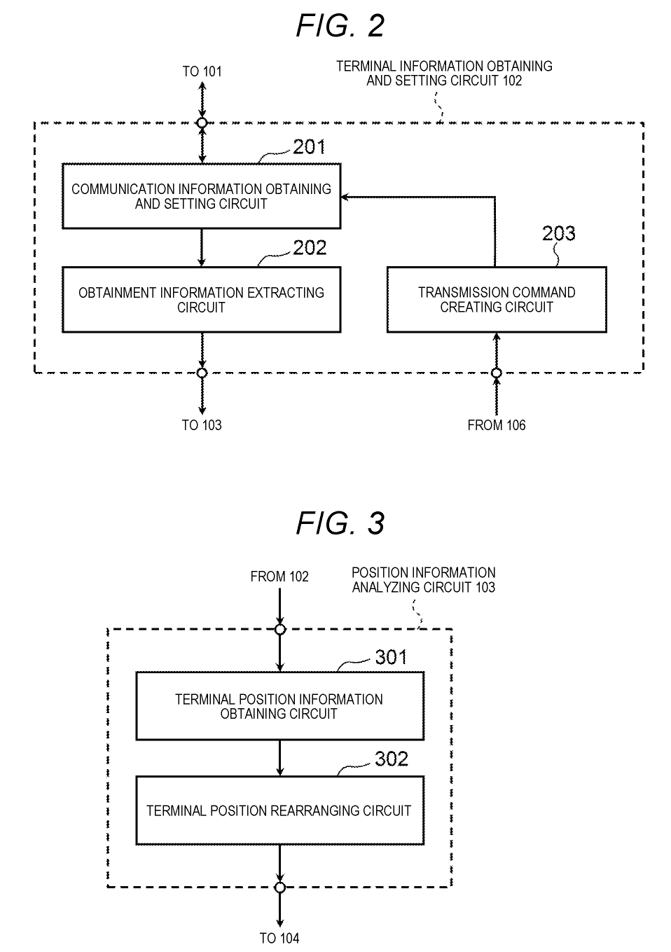

FIG. 2 is a block diagram illustrating a configuration example of terminal information obtaining and setting circuit 102 of FIG. 1B. In FIG. 2, terminal information obtaining and setting circuit 102 includes communication information obtaining and setting circuit 201, obtainment information extracting circuit 202, and transmission command creating circuit 203.

In FIG. 2, communication information obtaining and setting circuit 201 periodically (periodically at predetermined period) obtains the terminal information of each of display terminal devices 1 and 2 connected to communication interface circuit 101 and connected to LAN 20. The obtained terminal information is transmitted to obtainment information extracting circuit 202.

Obtainment information extracting circuit 202 extracts the plurality of the position information of display terminal devices 1 and 2 and the terminal specific information such as the IP address and the terminal name from the received terminal information, and outputs the extracted information to position information analyzing circuit 103.

Transmission command creating circuit 203 is connected to terminal control circuit 106, and receives the control signal from terminal control circuit 106. This control signal includes the control command of each of display terminal devices 1 and 2. Transmission command creating circuit 203 creates a transmission command to be transmitted to display terminal devices 1 and 2 that are a control target from the control signal, and then outputs the created transmission command to communication interface circuit 101 through communication information obtaining and setting circuit 201. There is a case where the control command output from terminal control circuit 106 includes the specific information relating to data transmission such as priority transmission information. In such a case, transmission command creating circuit 203 can change an order of outputting the created transmission command according to priority to communication interface circuit 101 through communication information obtaining and setting circuit 201.

### 1-1-3. Configuration of Position Information Analyzing Circuit

FIG. 3 is a block diagram illustrating a configuration example of position information analyzing circuit 103 of FIG. 1B. In FIG. 3, position information analyzing circuit 103 includes terminal position information obtaining circuit 301 and terminal position rearranging circuit 302.

In FIG. 3, terminal position information obtaining circuit 301 extracts information for specifying a position such as the IP address information and the position information from the terminal information of display terminal devices 1 and 2 received from terminal information obtaining and setting circuit 102. The extracted information is output to terminal position rearranging circuit 302. Terminal position rearranging circuit 302 specifies an arrangement rule of the plurality of display terminal devices 1 and 2, according to the information extracted by terminal position information obtaining circuit 301 and information format (ascending order, arrangement information, or the like).

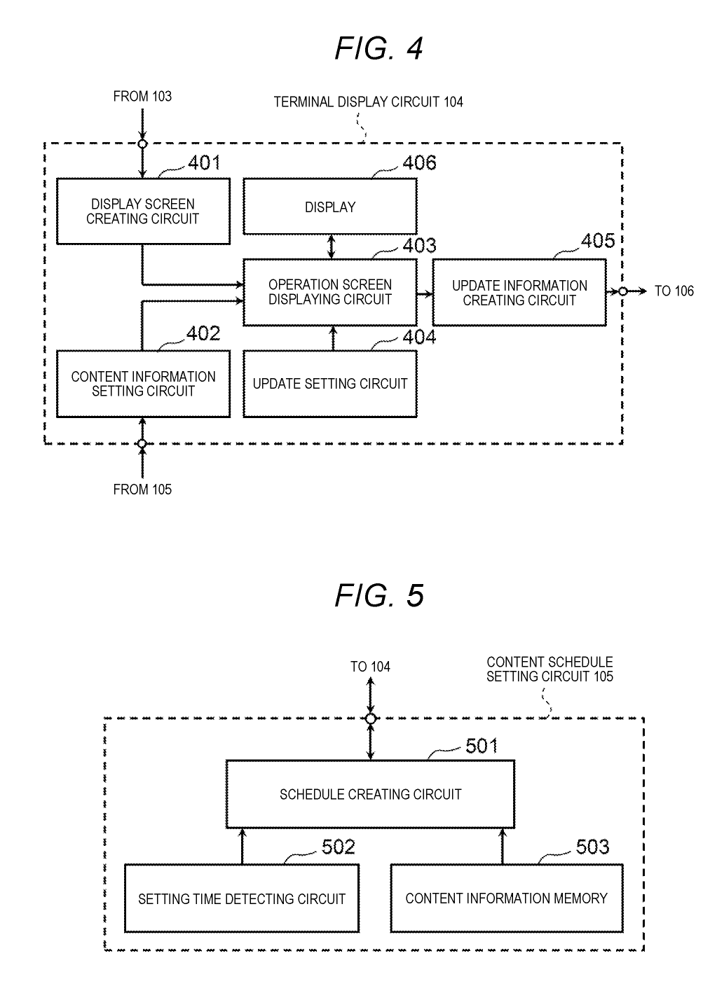

Terminal position rearranging circuit 302 rearranges and update the arrangement rule, and outputs the updated rearrangement information to display screen creating circuit 401 (FIG. 4).

### 1-1-4. Configuration of Terminal Display Circuit

FIG. 4 is a block diagram illustrating a configuration example of terminal display circuit 104 of FIG. 1B. In FIG. 4, terminal display circuit 104 includes display screen creating circuit 401, content information setting circuit 402, operation screen displaying circuit 403 including display 406, update setting circuit 404, and update information creating circuit 405.

In FIG. 4, display screen creating circuit 401 creates information of the operation screen indicating screen arrangement of display terminal devices 1 and 2 according to rearrangement information received from position information analyzing circuit 103. The information of the operation screen is output to operation screen displaying circuit 403.

Content information setting circuit 402 lists the content information received from content schedule setting circuit 105 which will be described below, and outputs the information thereof to operation screen displaying circuit 403.

Operation screen displaying circuit 403 displays the operation screen on display 406 based on the information of the operation screen received from display screen creating circuit 401. In addition, operation screen displaying circuit 403 displays a content screen on display 406 based on the content information processed as a list received from content information setting circuit 402. The operation screen and the content screen displayed on display 406 can be operated by a user. The user performs an association operation of the plurality of display terminal devices 1 and 2 and a content list on display 406.

Update setting circuit 404 outputs update permission information issued at the time of confirming the operation of the user to operation screen displaying circuit 403. Operation screen displaying circuit 403 outputs control information of display terminal devices 1 and 2 associated by a user operation to update information creating circuit 405 based on the update permission information output from update setting circuit 404.

Update information creating circuit 405 outputs the control information of display terminal devices 1 and 2 received from operation screen displaying circuit 403 and the terminal specific information as update information of display terminal devices 1 and 2 to terminal control circuit 106 of each of display terminal devices 1 and 2.

### 1-1-5. Configuration of Content Schedule Setting Circuit

FIG. 5 is a block diagram illustrating a configuration example of content schedule setting circuit 105 of FIG. 1B. In FIG. 5, content schedule setting circuit 105 includes schedule creating circuit 501, setting time detecting circuit 502, and content information memory 503.

In FIG. 5, schedule creating circuit 501 creates the delivery schedule of content, and outputs the created delivery schedule to terminal display circuit 104 based on current time information set in setting time detecting circuit 502, schedule performance time information that is time information of a schedule of performing content, and the content information to be delivered stored in content information memory 503. That is, content schedule setting circuit 105 sets the reproduction content information displayed on the plurality of display terminal devices and the time information to be reproduced.

### 1-1-6. Configuration of Terminal Control Circuit

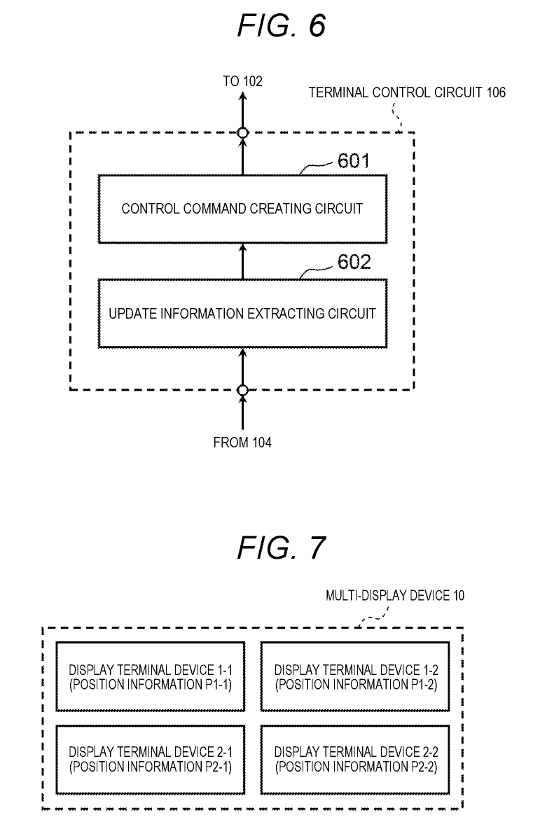

FIG. 6 is a block diagram illustrating a configuration example of terminal control circuit 106 of FIG. 1B. In FIG. 6, terminal control circuit 106 includes control command creating circuit 601 and update information extracting circuit 602.

In FIG. 6, update information extracting circuit 602 extracts the terminal specific information of each of display terminal devices 1 and 2 and the control information required for the update from the update information of display terminal devices 1 and 2 received from terminal display circuit 104. The extracted information is output to control command creating circuit 601. Control command creating circuit 601 determines a type of the control information with respect to each of display terminal devices 1 and 2, adds command information to the update information, and thus creates the control command based on information received from update information extracting circuit 602. The created control command is output to terminal information obtaining and setting circuit 102.

So far, each circuit configuration configuring content control device 30 is described. Content control device 30 is configured by a central processing unit (CPU), a micro processing unit (MPU), and the like. In addition, content control device 30 can also be configured with a digital signal processor (DSP), a field-programmable gate array (FPGA), an application-specific integrated circuit (ASIC), or the like.

### 1-2. Operation

An operation of the display system configured as described above including content control device 30 will be described in detail with reference to FIG. 7 to FIG. 13.

### 1-2-1. Obtainment of Position Information of Display Terminal Device

FIG. 7 is a diagram illustrating an example of an arrangement state of the plurality of display terminal devices 1-1 to 2-2 in multi-display device 10 of FIG. 1A. In FIG. 7, an example of a case where four display terminal device 1-1 to 2-2 are arranged at up, down, left, and right positions is illustrated as an example. Here, the position information of each of display terminal devices 1-1 to 2-2 is set as follows.

(1) The position information of display terminal device 1-1: P1-1;
(2) The position information of display terminal device 1-2: P1-2;
(3) The position information of display terminal device 2-1: P2-1;
(4) The position information of display terminal device 2-2: P2-2.

Terminal information obtaining and setting circuit 102 obtains terminal information as a communication terminal of display terminal devices 1-1 to 2-2 from the plurality of display terminal devices 1-1 to 2-2 connected to LAN 20.

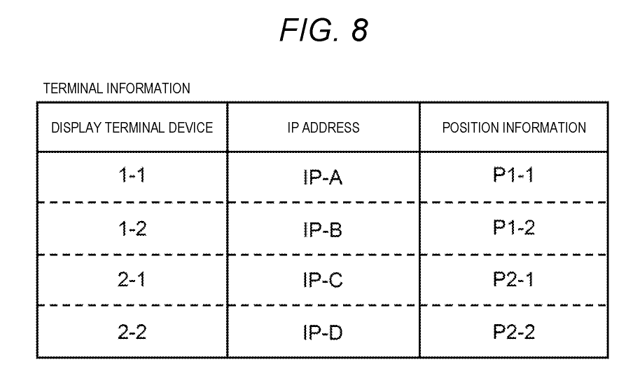

FIG. 8 is a diagram illustrating an example of the terminal information obtained in terminal information obtaining and setting circuit 102 of FIG. 1B. As an example, in FIG. 8, the name and the IP address of the display terminal device that are the terminal specific information and the position information are illustrated. It is also possible to add information such as information set for each of display terminal devices 1 and 2, for example, information such as a physical address and master/slave setting for configuring multi-display device 10, in addition to the terminal specific information.

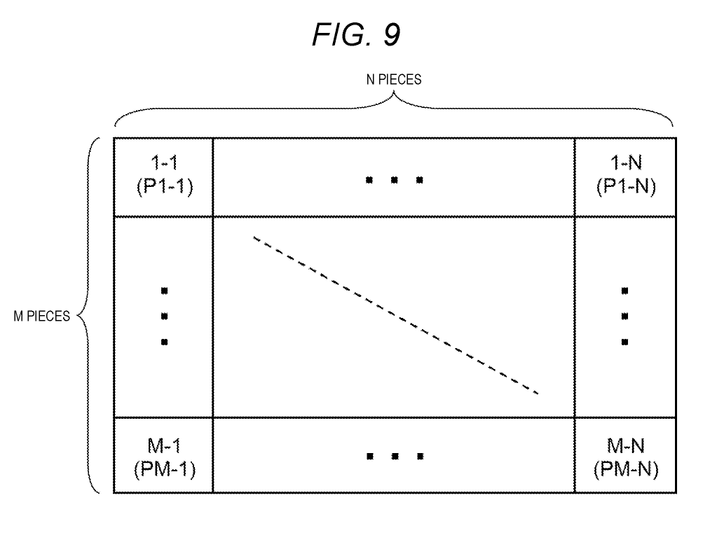

FIG. 9 is a diagram illustrating an arrangement example of the plurality of display terminal devices 1 and 2 in multi-display device 10 of FIG. 1A. In FIG. 9, an arrangement example in a case where the number of display terminal devices 1 and 2 are greater than four devices of FIG. 7 is illustrated. In FIG. 9, an example in a case where M×N display terminal devices 1-1 to M-N are arranged in positions of the number of pieces of the position information P1-1 to PM-N is illustrated. In this case, a list of M×N display terminal devices 1-1 to M-N is created in terminal information obtaining and setting circuit 102.

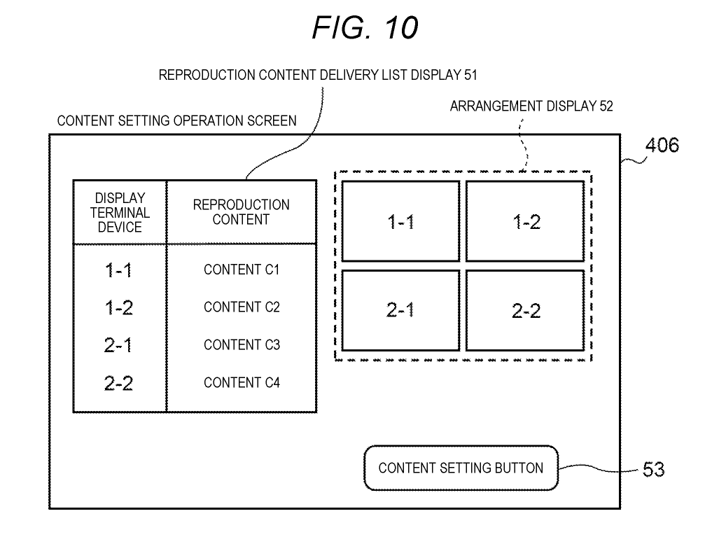

FIG. 10 is a diagram illustrating an example of a content setting operation screen displayed by terminal display circuit 104 of FIG. 1B. As illustrated in FIG. 10, the content setting operation screen includes reproduction content delivery list display 51, arrangement display 52, and content setting button 53. In an example of this content setting operation screen, terminal display circuit 104 calculates the maximum number of pieces in up, down, left, and right directions from the position information of each of display terminal devices 1-1 to 2-2 extracted in position information analyzing circuit 103, and creates arrangement display of an interface on a user operation screen.

Terminal display circuit 104 displays arrangement information of display terminal devices 1-1 to 2-2 on the content setting operation screen as arrangement display 52 based on the extracted position information of display terminal devices 1-1 to 2-2. In addition, terminal display circuit 104 displays reproduction content delivery list display 51 on the content setting operation screen based on the content information to be delivered set in content schedule setting circuit 105. Here, the reproduction content to be associated with each of display terminal devices 1-1 to 2-2 can be changed by a user's operation until content setting button 53 is pressed. When the user presses content setting button 53, the update permission information is issued from update setting circuit 404. When the update permission information is issued, update information creating circuit 405 outputs the reproduction content displayed on each of display terminal devices 1-1 to 2-2 as the update information to terminal control circuit 106. In response to this, terminal control circuit 106 transmits the reproduction content information to terminal information obtaining and setting circuit 102 based on the reproduction content information and the time information which are set. Terminal information obtaining and setting circuit 102 transmits the received the reproduction content information to each of display terminal devices 1-1 to 2-2 by using a predetermined communication command through communication interface circuit 101 and LAN 20.

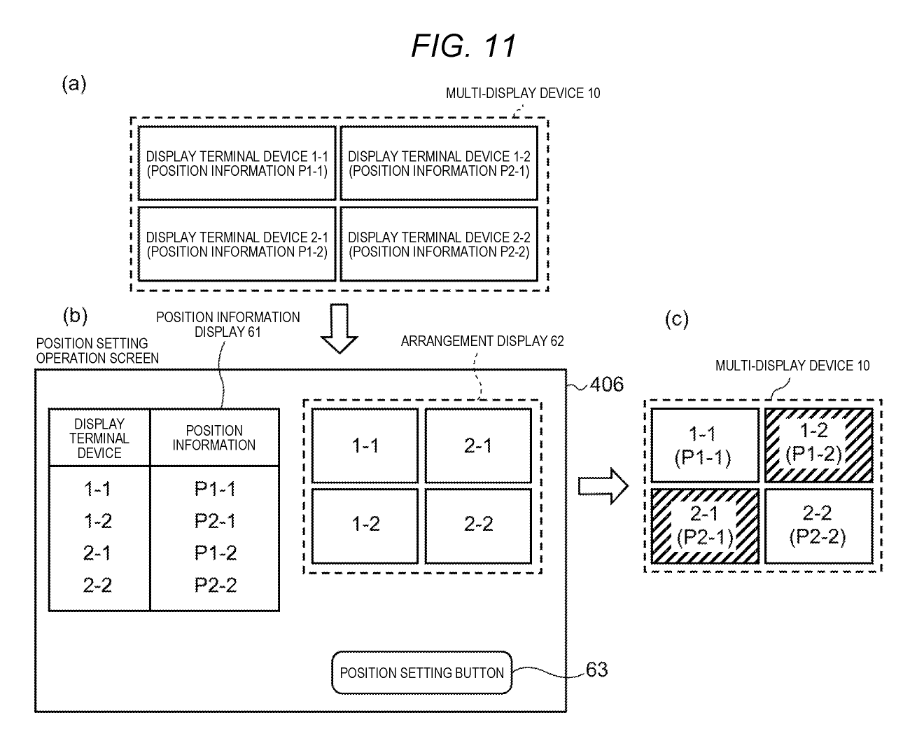

FIG. 11 is a diagram for explaining an example of setting change of the position information in the plurality of display terminal devices by terminal display circuit 104 of FIG. 1B. (a) of FIG. 11 is a diagram illustrating the arrangement position of display terminal devices 1-1 to 2-2 in multi-display device 10. (b) of FIG. 11 is a diagram illustrating an example of a position setting operation screen. (c) of FIG. 11 is a diagram illustrating the arrangement position of display terminal devices 1-1 to 2-2 in multi-display device 10 after setting change of the position information.

As illustrated in (a) of FIG. 11, in a case where display terminal devices 1-1 to 2-2 are respectively arranged at positions of the number of pieces of the position information P1-1 to P2-2, the position setting operation screen of (b) of FIG. 11 is displayed on display 406 that is a user interface for performing a user's operation. In (b) of FIG. 11, position information display 61, arrangement display 62, and position setting button 63 are illustrated. Here, when comparing an arrangement state in (a) of FIG. 11 and arrangement display 62 of (b) of FIG. 11, it is possible to determine that the position information of display terminal devices 1-2 and 2-1 is wrong. In this case, for example, the arrangement position of display terminal device 1-2 and the arrangement position of the display terminal device 2-1 displayed on arrangement display 62 can be changed by a user's operation such as the drag of a mouse. With this, it is possible to change the position information displayed on position information display 61.

After changing the arrangement position, by pressing position setting button 63, the update permission information is issued from update setting circuit 404. The issued update permission information as position information change information is output to display terminal devices 1-2 and 2-1 of targets from terminal display circuit 104 through terminal control circuit 106 and terminal information obtaining and setting circuit 102. Similar to delivery of the content information, terminal control circuit 106 creates a predetermined transmission command, and transmits the position information update information to each of display terminal devices 1-2 and 2-1 through terminal information obtaining and setting circuit 102, communication interface circuit 101, and LAN 20. With this, it is possible to update the position information of display terminal devices 1-2 and 2-1 as illustrated in (c) of FIG. 11.

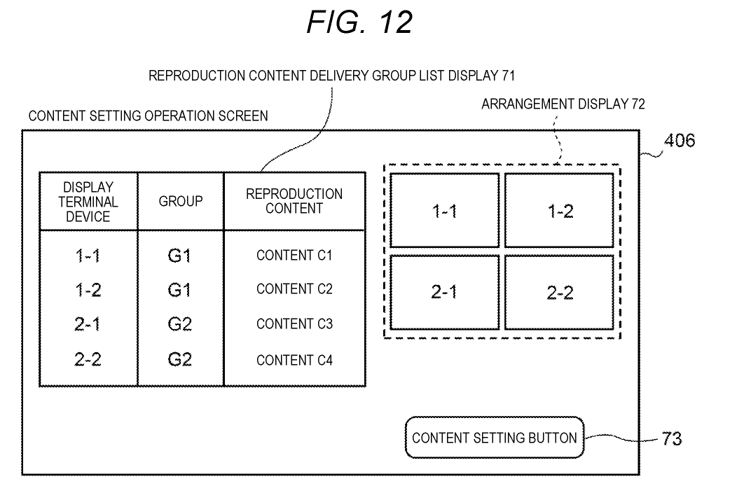

FIG. 12 is a diagram illustrating another example of the content setting operation screen displayed by terminal display circuit 104 of FIG. 1B. As illustrated in FIG. 12, the content setting operation screen includes reproduction content delivery group list display 71, arrangement display 72, and content setting button 73. In an example of this content setting operation screen, terminal display circuit 104 calculates the maximum number of pieces in up, down, left, and right directions from the position information of each of display terminal devices 1-1 to 2-2 extracted in position information analyzing circuit 103, and creates arrangement display of an interface on a user operation screen. In addition, position information analyzing circuit 103 analyzes terminal information, extracts group information of display terminal devices 1-1 to 2-2, and outputs the extracted group information to terminal display circuit 104.

Terminal display circuit 104 displays the arrangement information of display terminal devices 1-1 to 2-2 on the content setting operation screen as displays arrangement display 72, based on the extracted position information of display terminal devices 1-1 to 2-2. In addition, terminal display circuit 104 displays reproduction content delivery group list display 71 associated to a group on the content setting operation screen based on the content information which can be delivered set in content schedule setting circuit 105. Here, the reproduction content associated with each of display terminal devices 1-1 to 2-2 can be changed by a user's operation until content setting button 73 is pressed.

When the user presses content setting button 73, the update permission information is issued from update setting circuit 404. When the update permission information is issued, update information creating circuit 405 outputs the reproduction content displayed on each of display terminal devices 1-1 to 2-2 as the update information to terminal control circuit 106. In response to this, terminal control circuit 106 transmits the reproduction content information to terminal information obtaining and setting circuit 102 based on the reproduction content information and the time information which are set. Terminal information obtaining and setting circuit 102 transmits the received the reproduction content information to each of display terminal devices 1-1 to 2-2 by using a predetermined communication command through communication interface circuit 101 and LAN 20.

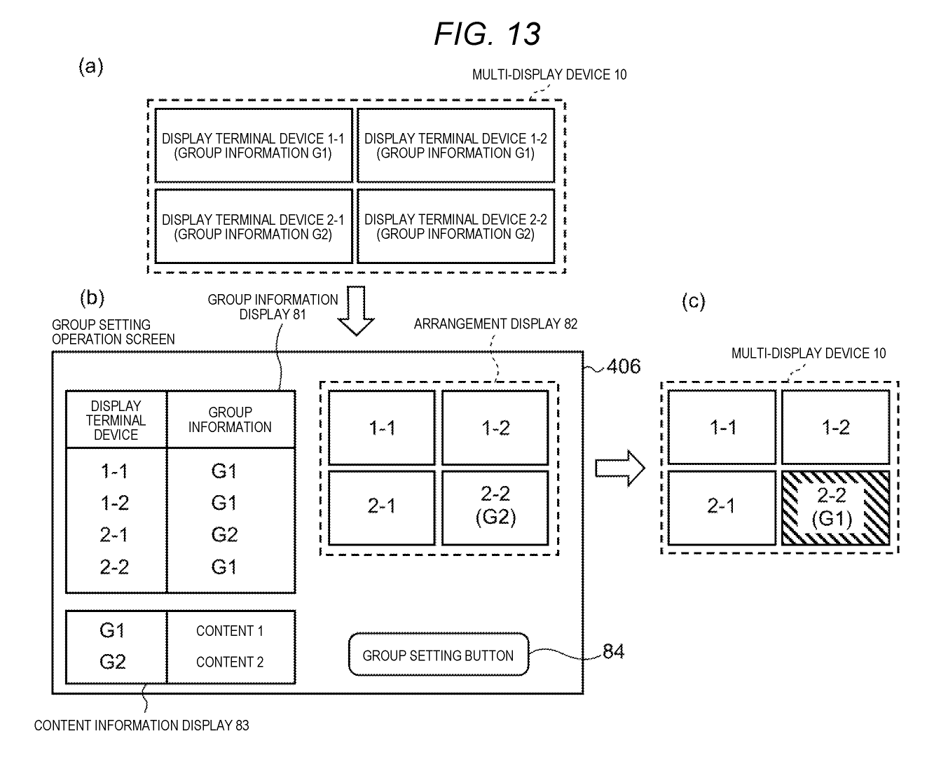

FIG. 13 is a diagram for explaining an example of setting change of the group information in the plurality of display terminal devices by terminal display circuit 104 of FIG. 1B. (a) of FIG. 13 is a diagram illustrating the arrangement positions of the plurality of display terminal devices in multi-display device 10. (b) of FIG. 13 is a diagram illustrating an example of a group setting operation screen. (c) of FIG. 13 is a diagram illustrating the arrangement positions of the plurality of display terminal devices 1-1 to 2-2 in multi-display device 10 after the setting change of group information.

As illustrated in (a) of FIG. 13, as a multi-display in which respective display terminal devices 1-1 to 2-2 are arranged at positions of pieces of the position information P1-1 to P2-2, display terminals are set as a group. In this case, the group setting operation screen of (b) of FIG. 13 is displayed on display 406 that is a user interface for performing an operation by a user. In (b) of FIG. 13, group information display 81, arrangement display 82, content information display 83, and group setting button 84 are displayed. Here, when comparing the group information in (a) of FIG. 13 and group information display 81 of (b) of FIG. 13, it is recognized that group information setting of the display terminal device 2-2 is different. For example, in a case where the group information of the display terminal device 2-2 displayed on group information display 81 is correct, the group information of the display terminal device 2-2 displayed on arrangement display 82 may be changed. Meanwhile, in a case where the group information of the display terminal device 2-2 displayed on arrangement display 82 is correct, the group information of the display terminal device 2-2 displayed on group information display 81 may be changed. In (c) of FIG. 13, a case where the group information of the display terminal device 2-2 displayed on arrangement display 82 is wrong is illustrated. In this case, it is possible to change group information display 81 or the group information described on arrangement display 82 by a user's operation.

After changing the group information, by pressing group setting button 84, the update permission information is issued from update setting circuit 404. The issued update permission information as group setting change information is output to display terminal device 2-2 of a target from terminal display circuit 104 through terminal control circuit 106 and terminal information obtaining and setting circuit 102. Similar to the delivery of the content information, terminal control circuit 106 creates a predetermined transmission command, and transmits the group setting change information to display terminal device 2-2 through terminal information obtaining and setting circuit 102, communication interface circuit 101, and LAN 20. With this, as (c) of FIG. 13, it is possible to change the group information of display terminal device 2-2.

In addition, by using content information display 83, since the reproduction content information to be associated with a group is freely selected from content information memory 503, it is possible to update the reproduction content information on a group basis of the display terminal.

### 1-3. Effect or the Like

As described above, content control device 30 according to the present disclosure includes terminal information obtaining and setting circuit 102 (information obtaining unit), position information analyzing circuit 103 (information analyzing unit), content schedule setting circuit 105 (setting unit), terminal display circuit 104 (terminal display unit), and terminal control circuit 106 (terminal control unit). Terminal information obtaining and setting circuit 102 performs communication with the plurality of display terminal devices 1 and 2 displaying a predetermined content which are connected to LAN 20 (network) through LAN 20, and thus obtains the terminal information of the plurality of display terminal devices 1 and 2. Position information analyzing circuit 103 analyzes the obtained terminal information, and extracts the plurality of the position information of display terminal devices 1 and 2 and the terminal specific information. Content schedule setting circuit 105 (setting unit) sets the reproduction content information displayed on the plurality of display terminal devices 1 and 2, and the time information to be reproduced. In addition, terminal display circuit 104 (terminal display unit) displays and sets information associating the extracted position information with the set reproduction content information. Terminal control circuit 106 delivers the set reproduction content information to the plurality of display terminal devices 1 and 2, and transmits a control signal for resetting the position information based on the set reproduction content information and the set time information.

According to this configuration, in a case where multi-display device 10 is constructed by using the plurality of display terminal devices 1 and 2 connected to LAN 20, the position information and the terminal specific information of each of display terminal devices 1 and 2 are obtained, and an operation screen to be operated by the user is created based on the obtained position information. With this, it is possible to simply grasp association between the position information and arrangement information of display terminal devices 1 and 2 which are arranged, or the group information and the reproduction content information of display terminal devices 1 and 2.

In addition, according to the display system including content control device 30 according to the present embodiment, by associating the content information to be delivered to the arranged display terminal devices 1 and 2 and by controlling a terminal at a predetermined time based on a schedule function, it is possible to more simply control reproduction of the content.

In addition, according to the display system including content control device 30 according to the present embodiment, by displaying current display state information (position information or the like) on display 406 of the operation screen, it is possible to simply change installation information by a user operation even if the installation position is incorrect, and it is possible to clarify relationship between the operation screen and display device.

### Another Embodiment

As described above, embodiments are described as examples of the technology disclosed in the present application. However, the technology in the present disclosure is not limited to this, and can also be applied to embodiments in which change, substitution, addition, omission and the like are performed. In addition, it is also possible to combine the respective constituent elements described in the above embodiments into a new embodiment.

Therefore, another embodiment will be exemplified below.

In the embodiment, as an example of the display system constituting multi-display device 10, the operation screen display method for a case where there are four display terminal devices is described. It can be used for specifying not only display terminal devices 1 and 2 connected to LAN 20 but also a communication terminal device. In addition, instead of display terminal devices 1-1 to M-N in which M×N pieces of the position information P1-N to PM-N described in the embodiment are set, it is also possible to construct an operation screen in accordance with a predetermined rule from ID information for specifying display terminal devices 1-1 to M-N, and a display screen may be constructed according to a user operation or usage.

Since the embodiments described above are intended to exemplify the technology in the present disclosure, it is possible to make various changes, replacements, additions, omissions, or the like within the scope of claims or the equivalent thereof.

The present disclosure can be applied to a content delivery control device that delivers content of a system constituting the multi-display. Particularly, it is effective to easily associate reproduction content information with a display terminal device without specifying a setting state of the display terminal device. In addition, by changing the setting of the display terminal device to be changed by operating the position information of the display terminal device from the operation screen by the user operation, it is possible to save the labor of reinstalling the display terminal device.

What is claimed is:

1. A content control device comprising:
an information obtaining unit that obtains terminal information of a plurality of display terminal devices by being connected to a network and performing communication with the plurality of display terminal devices displaying predetermined content through the network;
an information analyzing unit that extracts position information and terminal specific information of the plurality of display terminal devices by analyzing the obtained terminal information;
a setting unit that sets reproduction content information to be displayed on the plurality of display terminal devices and time information to be reproduced;
a terminal display unit that displays and sets information obtained by associating the extracted position information with the set reproduction content information; and
a terminal control unit that delivers the set reproduction content information to the plurality of display terminal devices, and performs transmitting a control signal for performing resetting of the position information based on the set reproduction content information and the set time information.

2. The content control device of claim 1,
wherein the terminal display unit displays the extracted position information and the extracted terminal specific information, and
the terminal control unit transmits the control signal for performing resetting of the position information to a corresponding display terminal device when the position information is changed by a predetermined operation.

3. The content control device of claim 1,
wherein in a case where information obtained by associating the position information with the reproduction content information is displayed by the terminal display unit, when the reproduction content information is changed and updated by a predetermined operation, the terminal control unit delivers the updated reproduction content information to the plurality of display terminal devices.

4. The content control device of claim 1,
wherein the information analyzing unit extracts group information of the plurality of display terminal devices by analyzing the terminal information,
the terminal display unit displays the position information, the terminal specific information, and the group information which are extracted, and
the terminal control unit transmits a control signal for performing resetting of the group information to a corresponding display terminal device and delivers the set reproduction content information on a group basis when the group information is changed by a predetermined operation.

5. A display system comprising:
a multi-display device that is configured by arranging a plurality of display terminal devices at predetermined positions, respectively; and
the content control device of claim 1.
